(19) United States
(12) Patent Application Publication
(10) Pub. No.: US 2022/0263193 A1
(43) Pub. Date: Aug. 18, 2022

(54) ELECTROCHEMICAL CELLS WITH SEPARATOR SEALS, AND METHODS OF MANUFACTURING THE SAME

(71) Applicant: 24M Technologies, Inc., Cambridge, MA (US)

(72) Inventors: Junzheng CHEN, Concord, MA (US); Naoki OTA, Lexington, MA (US); Matt TYLER, New York, NY (US); Nathan COSTA, Brighton, MA (US); Landon OAKES, Cambridge, MA (US)

(73) Assignee: 24M Technologies, Inc., Cambridge, MA (US)

(21) Appl. No.: 17/729,793

(22) Filed: Apr. 26, 2022

Related U.S. Application Data
(63) Continuation of application No. PCT/US2020/058564, filed on Nov. 2, 2020.
(60) Provisional application No. 63/046,758, filed on Jul. 1, 2020.
(60) Provisional application No. 62/929,408, filed on Nov. 1, 2019.

(51) Int. Cl. H01M 50/414; H01M 50/497; H01M 50/46

(52) U.S. Cl. CPC H01M 50/414; H01M 50/461; H01M 50/497

(57) ABSTRACT

Embodiments described herein relate to electrochemical cells having a separator with a separator seal. In some embodiments, an electrochemical cell includes an anode disposed on an anode current collector, a cathode disposed on a cathode collector, a separator disposed between the anode and the cathode, and a separator seal coupled to the separator. The separator seal is impermeable to the movement of electroactive species therethrough. In some embodiments, the separator seal can include a tape and/or an adhesive. In some embodiments, the separator seal can include a material that permeates into pores of a portion of the separator. In some embodiments, the separator seal can be thermally bonded to the separator. In some embodiments, the electrochemical cell can include a pouch. In some embodiments the separator can be coupled to the pouch. In some embodiments, the separator seal can be coupled to the pouch.

### CROSS-REFERENCE TO RELATED APPLICATIONS

This application claims the priority to and the benefit of U.S. Provisional Application No. 62/929,408, entitled “DUAL ELECTROLYTE ELECTROCHEMICAL CELLS, SYSTEMS, AND METHODS OF MANUFACTURING THE SAME” and filed on Nov. 1, 2019 and U.S. Provisional Application No. 63/046,758, entitled “ELECTROCHEMICAL CELLS WITH SEPARATOR SEALS, AND METHODS OF MANUFACTURING THE SAME” and filed on Jul. 1, 2020, the disclosures of each of which are hereby incorporated by reference in their entirety.

### BACKGROUND

Embodiments described herein relate to electrochemical cells having a separator with a separator seal. Electrochemical cells are often designed with an anode having dimensions different from dimensions of a cathode. The anode and cathode can differ not only in thickness, but in length and width. Generally in electrochemical cell design, the anode and cathode should have lengths and width dimensions as close to each other as possible, to maximize cell efficiency and usage of electroactive species. However, if the cathode shifts laterally, edges of the cathode can extend beyond edges of the anode and plating of cathode material can occur around the edges of the anode. Designing the anode to have slightly larger length and width dimensions than the cathode can prevent plating of cathode material around the outside edges of the anode. However, designing the anode to have length and width dimensions slightly larger than the cathode length and width dimensions can lead to plating of anode material around the edges of the cathode. During discharge, positive ions are migrating from the anode through a separator to the cathode. If the anode is longer and wider than the cathode, some positive ions can migrate from a portion of the anode that extends beyond the edges of the cathode. In other words, positive ions can migrate from a portion of the anode that is not in-line with the cathode. This can result in a buildup of anode material on the cathode side of the separator. If enough anode material builds up on the cathode side, the cathode can directly contact the anode material, causing a partial or full short circuit.

Another plating issue that can occur in electrochemical cells relates to coating quality. In an electrochemical cell, electrode material can be coated on a current collector, and the coating quality is often poorer near the edges than near the middle of the electrodes. In some cases, the electrode can have slightly lower loading of material at the edge, leaving room for material from the counter electrode to plate near the edge of the electrode. This can also cause a partial or full short circuit. Partially blocking the flow of anode or cathode materials near the electrode edges can help prevent such short circuit events.

### SUMMARY

Embodiments described herein relate to electrochemical cells having a separator with a separator seal. In some embodiments, the electrochemical cell includes an anode disposed on an anode current collector, a cathode disposed on a cathode collector, a separator disposed between the anode and the cathode, and a separator seal coupled to the separator. The separator seal is impermeable to the movement of electroactive species therethrough. In some embodiments, the separator seal can include a tape and/or an adhesive. In some embodiments, the separator seal can include a material that permeates into pores of a portion of the separator. In some embodiments, the separator seal can be thermally bonded to the separator. In some embodiments, the electrochemical cell can include a pouch. In some embodiments the separator can be coupled to the pouch. In some embodiments, the separator seal can be coupled to the pouch.

### BRIEF DESCRIPTION OF THE DRAWINGS

FIG. 1 shows an electrochemical cell subject to a short circuit from deposition of anode material.

FIG. 2 is a schematic illustration of an electrochemical cell having a separator with a separator seal, according to an embodiment.

FIGS. 3A and 3B show an electrochemical cell with a separator seal, according to an embodiment.

FIGS. 4A and 4B show an electrochemical cell with a separator seal, according to an embodiment.

FIGS. 5A and 5B show an electrochemical cell with a separator seal, according to an embodiment.

FIGS. 6A and 6B show an electrochemical cell with a separator seal, according to an embodiment.

FIGS. 7A-7C show a wound electrochemical cell with a separator seal, according to an embodiment.

FIGS. 8A-8C show a photograph of a deconstructed electrochemical cell, according to an embodiment.

FIGS. 9A-9C show a photograph of a deconstructed electrochemical cell, according to an embodiment.

FIGS. 10A-10G show a photograph of a deconstructed electrochemical cell, according to an embodiment.

FIGS. 11A and 11B show an electrochemical cell with a separator seal, according to an embodiment.

### DETAILED DESCRIPTION

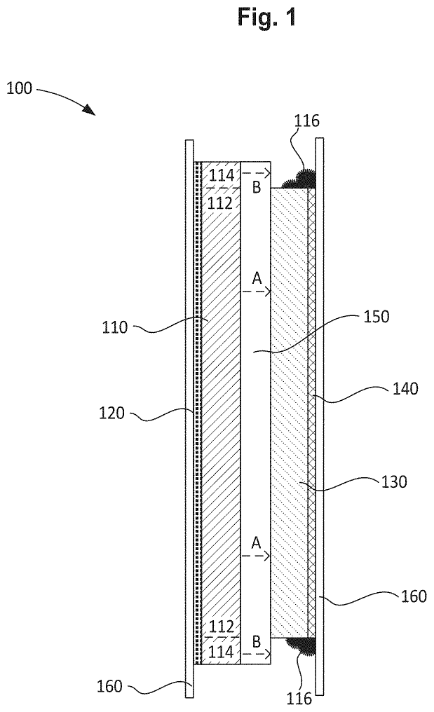

Embodiments described herein relate to electrochemical cells having a separator with a separator seal, and methods of producing the same. Short circuit events in electrochemical cells can often be caused by the deposition of anode material near the cathode or by the deposition of cathode material near the cathode. Once enough anode material has built up near the cathode, or vice versa, physical contact between anode material and cathode material can lead to a short circuit event. An example of this behavior is shown in FIG. 1. FIG. 1 shows an electrochemical cell 100 with an anode 110 disposed on an anode current collector 120, a cathode 130 disposed on a cathode current collector 140, and a separator 150 disposed between the anode 110 and the cathode 130. The anode current collector 120 and the cathode current collector 140 are both disposed on a pouch material 160. As shown, the anode 110 has a first section 112 and a second section 114. The first section 112 is in-line with the cathode 130 while the second section 114 is not in-line with the cathode 130. In other words, ions migrate from the first section 112 to the cathode 130 via lines A. Ions migrate from the second section 114 via lines B, but since the second section 114 is not in-line with the cathode 130, anode material deposits 116 form near the cathode 130, either on the surface of the cathode current collector 140 or on the surface of the pouch material 160. When the anode material deposits 116 are large enough to physically contact the cathode 130, a partial or full short circuit event can result. Additionally, the anode material deposits 116 represent material that has separated from the anode 110, such that it can no longer be used in the cycling of the electrochemical cell 100. This can negatively affect the cycling performance of the electrochemical cell 100.

The use of a separator seal or a device that can prevent the flow of ions through a portion of the separator can substantially reduce the risk of a short circuit event. Reducing the risk of a short circuit event can be an economic advantage as well as a safety advantage. Removing anode material deposited near the cathode (or cathode material deposited near the anode often requires opening a pouch to access the anode material and cathode material and carefully removing the deposited material without disturbing the intact portions of the electrochemical cell. This is a labor-intensive process and causes downtime for the electrochemical cell. If the electrochemical cell is included in a battery pack with multiple electrochemical cells, each of the electrochemical cells in the battery pack would experience downtime. In some cases, if the deposit of anode material near the cathode (or cathode material near the anode is too large to be removed, the electrochemical cell can be subject to disposal or recycling. Preventing short circuit events can also be a safety advantage. Short circuit events can often cause a rapid rise in temperature in the electrochemical cell, possibly leading to thermal runaway, fires or explosions.

By incorporating a separator seal into the separator, the flow of ions through the separator can be guided such that the flow of ions is only between the anode and the cathode and electroactive material does not build up in an undesired location. In some embodiments, the separator seal can be a part of the separator. In other words, the separator and the separator seal can be a single piece of material with a first portion permeable to the flow of ions and a second portion impermeable to the flow of ions. In some embodiments, the separator seal can be two separate pieces of material, with the separator seal coupled to the separator. In some embodiments, the separator can have multiple layers, with a first layer including a section substantially impermeable to ions and a second layer does not include a section substantially impermeable to ions.

In some embodiments, the separator can be a porous membrane separator (e.g., a porous polyolefin membrane. In some embodiments, the separator can allow for the transfer of ionic charge carriers between the cathode and the anode. In some embodiments, the separator can be wetted by the electrolyte and can communicate the electrolyte between the anode and the cathode. In some embodiments, the electrochemical cell can include a selectively permeable membrane. Examples of electrochemical cells that include a separator with a selectively permeable membrane that can chemically and/or fluidically isolate the anode from the cathode while facilitating ion transfer during charge and discharge of the cell are described in U.S. Pat. No. 10,734,672 entitled, “Electrochemical Cells Including Selectively Permeable Membranes, Systems and Methods of Manufacturing the Same,” filed Jan. 8, 2019 (“the '672 patent”), the disclosure of which is incorporated herein by reference in its entirety.

In some embodiments, the electrodes described herein can include a semi-solid material. Examples of systems and methods that can be used for preparing the semi-solid compositions and/or electrodes are described in U.S. Pat. No. 9,484,569 (hereafter “the '569 Patent”), filed Mar. 15, 2013, entitled “Electrochemical Slurry Compositions and Methods for Preparing the Same,” U.S. Pat. No. 8,993,159 (“the '159 Patent”), filed Apr. 29, 2013, entitled “Semi-Solid Electrodes Having High Rate Capability,” and U.S. Patent Publication No. 2016/0133916 (“the '916 Publication”), filed Nov. 4, 2015, entitled “Electrochemical Cells Having Semi-Solid Electrodes and Methods of Manufacturing the Same,” the entire disclosures of which are hereby incorporated by reference herein.

In some embodiments, the electrodes and/or the electrochemical cells described herein can include solid-state electrolytes. In some embodiments, anodes described herein can include a solid-state electrolyte. In some embodiments, cathodes described herein can include a solid-state electrolyte. In some embodiments, electrochemical cells described herein can include solid-state electrolytes in both the anode and the cathode. In some embodiments, the electrochemical cells described herein can include unit cell structures with solid-state electrolytes. In some embodiments, the solid-state electrolyte material can be a powder mixed with the binder and then processed (e.g. extruded, cast, wet cast, blown, etc.) to form the solid-state electrolyte material sheet. In some embodiments, solid-state electrolyte material is one or more of oxide-based solid electrolyte materials including a garnet structure, a perovskite structure, a phosphate-based Lithium Super Ionic Conductor (LISICON) structure, a glass structure such as La_{0.51}Li_{0.34}TiO_{2.94}, Li_{1.3}Al_{0.3}Ti_{1.7}(PO₄)₃, Li_{1.4}Al_{0.4}Ti_{1.6}(PO₄)₃, Li₇La₃Zr₂O₁₂, Li_{6.66}La₃Zr_{1.6}Ta_{0.4}O_{12.9} (LLZO), 50Li₄SiO₄.50Li₃BO₃, Li_{2.9}PO_{3.3}N_{0.46} (lithium phosphorousoxynitride, LiPON), Li_{3.6}Si_{0.6}P_{0.4}O₄, Li₃BN₂, Li₃BO₃—Li₂SO₄, Li₃BO₃—Li₂SO₄—Li₂CO₃ (LIBSCO, pseudoternary system), and/or sulfide contained solid electrolyte materials including a thio-LISICON structure, a glassy structure and a glass-ceramic structure such as Li_{1.07}Al_{0.69}Ti_{1.46}(PO₄)₃, Li_{1.5}Al_{0.5}Ge_{1.5}(PO₄)₃, Li₁₀GeP₂S₁₂ (LGPS), 30Li₂S.26B₂S₃.44LiI, 63Li₂S.36SiS₂.1Li₃PO₄, 57Li₂S.38SiS₂.5Li₄SiO₄, 70Li₂S.30P₂S₅, 50Li₂S.50GeS₂, Li₇P₃S₁₁, Li_{3.25}P_{0.95}S₄, and Li_{9.54}Si_{1.74}P_{1.44}S_{11.7}Cl_{0.3}, and/or closo-type complex hydride solid electrolyte such as LiBH₄—LiI, LiBH₄—LiNH₂, LiBH₄—P₂S₅, Li(CB_{X}H_{X+1})—LiI like Li(CB₉H₁₀)—LiI, and/or lithium electrolyte salt bis(trifluoromethane)sulfonamide (TFSI), bis(pentalluoroethanesulfonyl)imide (BETI), bis(fluorosulfonyl)imide, lithium borate oxalato phosphine oxide (LiBOP), lithium bis(fluorosulfonyl)imide, amide-borohydride, LiBF₄, LiPF₆ LIF, or combinations thereof. In some embodiments, electrodes described herein can include about 40 wt. % to about 90 wt % solid-state electrolyte material. Examples of electrochemical cells and electrodes that include solid-state electrolytes are described in the '672 patent.

In manufacturing, a battery cell can be constructed by stacking alternating layers of electrodes (typical for high-rate capability prismatic cells), or by winding long strips of electrodes into a “jelly roll” configuration (typical for cylindrical cells). Electrode stacks or rolls can be inserted into hard cases that are sealed with gaskets (most commercial cylindrical cells), laser-welded hard cases, or enclosed in foil pouches with heat-sealed seams (commonly referred to as lithium-ion polymer cells).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the term “conventional separator” means an ion permeable membrane, film, or layer that provides electrical isolation between an anode and a cathode, while allowing charge carrying ions to pass therethrough. Conventional separators do not provide chemical and/or fluidic isolation of the anode and cathode.

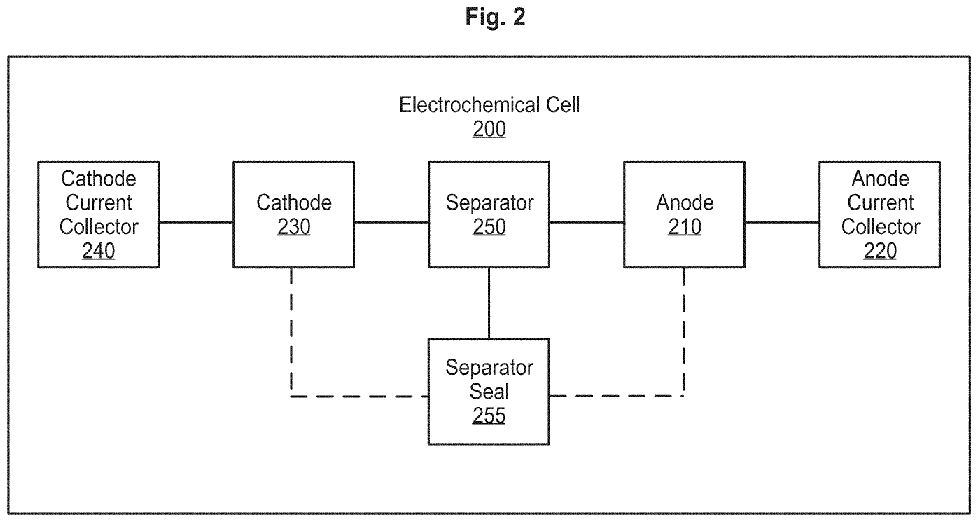

FIG. 2 is a schematic illustration of an electrochemical cell 200, according to an embodiment. The electrochemical cell 200 includes an anode 210 disposed on an anode current collector 220, a cathode 230 disposed on a cathode current collector 240, and a separator 250 disposed between the anode 210 and the cathode 230. As shown, the separator 250 includes a separator seal 255. In some embodiments, the separator seal 255 can block the flow of electroactive species through some portions of the separator 250. In some embodiments, the separator seal 255 can prevent or substantially prevent plating or buildup of electroactive materials near the anode 210 or the cathode 230. Preventing buildup of electroactive materials can improve electroactive material retention in the anode 210 and the cathode 230 (i.e., the electrodes), and can thus improve capacity retention of the electrochemical cell 200. Preventing buildup of electroactive materials can also prevent short circuit events from occurring in the electrochemical cell 200.

In some embodiments, the separator seal 255 can be composed of a polymer material. In some embodiments, the separator seal 255 can be composed of polyethylene, polypropylene, high density polyethylene, polyethylene terephthalate, polystyrene, or any other suitable material. In some embodiments, the separator seal 255 can be composed of the same or substantially the same material as the separator 250. In some embodiments, the separator seal 255 can be composed of a different material from the separator 250. In some embodiments, the separator seal 255 can be an adhesive material. In some embodiments, the separator seal 255 can include a cement, a mucilage, a glue, and/or a paste. In some embodiments, the separator seal 255 can include Kapton tape, an inorganic insulating ceramic, alumina, silica, boehmite, silicon carbide, aluminum carbide, or any combination thereof. In some embodiments, the separator seal 255 can be an organic material. In some embodiments, the separator seal 255 can be an oil. In some embodiments, the separator 250 can include pores. In some embodiments, the separator seal 255 can be a thermosetting polymer or thermosetting resin. In some embodiments, the separator seal 255 can be a material that permeates into pores of the separator 250 and blocks the flow of electroactive materials therethrough.

In some embodiments, the separator seal 255 can include a coating material that coats a portion of the separator 250. In some embodiments, the coating material can block flow of electroactive species through the pores in a portion of the separator 250. In some embodiments, the coating material can include polyethylene, polypropylene, high density polyethylene, polyethylene terephthalate, polystyrene, a thermosetting polymer, hard carbon, a thermosetting resin, a polyimide, or any other suitable coating material or any combinations thereof. In some embodiments, the separator seal 255 can include an electrostatic coating. In some embodiments, the separator seal 255 can be a tape coupled to a single side of the separator 250. In some embodiments, a portion of the separator 250 can be melted and cured to close pores in a portion of the separator 250 and form the separator seal 255. In some embodiments, a portion of the separator 250 can be UV-cured to form the separator seal 255. In some embodiments, the separator seal 255 can be disposed on a single side of the separator 250. In some embodiments, the separator seal 255 can be disposed on both sides of the separator 250. In some embodiments, the separator seal 255 can be a tape coupled to both sides of the separator 250. In some embodiments, the separator seal 255 can be thermally bonded to the separator 250. In some embodiments, the separator 250 can be partially coated in adhesive material. In some embodiments, portions of the separator 250 coated with adhesive material can be heated and cured to form the separator seal 255. In some embodiments, the separator 250 can be partially coated in a ceramic coating, and a binder material of a ceramic coating can be melted and cured to form the separator seal 255. In some embodiments, a portion of the separator 250 can be mechanically pressed to close pores and form the separator seal 255.

In some embodiments, the separator 250 can be coupled to the anode 210 and/or the cathode 230 to prevent lateral movement or misalignment of the anode 210 and/or the cathode 230 during construction or transport of the electrochemical cell 200. In some embodiments, the separator 250 can be adhesively coupled to the anode 210 and/or the cathode 230. In some embodiments, the adhesive coupling between the separator 250 and the anode 210 can be the separator seal 255 or a portion of the separator seal 255. In some embodiments, the adhesive coupling between the separator 250 and the anode 210 can be separate from the separator seal 255. In some embodiments, the adhesive coupling between the separator 250 and the cathode 230 can be the separator seal 255 or a portion of the separator seal 255. In some embodiments, the adhesive coupling between the separator 250 and the cathode 230 can be separate from the separator seal 255.

In some embodiments, the separator seal 255 can be coupled to the separator 250. In some embodiments, the separator seal 255 can make physical contact with the anode 210. In some embodiments, the separator seal 255 can make physical contact with the cathode 230. In some embodiments, the separator seal 255 can make physical contact with both the anode 210 and the cathode 230. In some embodiments, the separator seal 255 can be coupled to a pouch (not shown). In some embodiments, the separator seal 255 can have a first side coupled to the pouch and a second side coupled to an electrode. In some embodiments, the separator seal 255 can be coupled to the pouch on both sides.

In some embodiments, the separator 250 and the separator seal 255 can be two separate pieces of material. For example, the separator seal 255 can be a polymer thermally bonded to a portion of the separator 250. In some embodiments, the separator 250 and the separator seal 255 can be two portions of the same piece of material. For example, the separator 250 can have a porous section and a nonporous section, wherein the nonporous section acts as the separator seal 255. In some embodiments, the separator seal 255 can be disposed around a perimeter of the separator 250. In some embodiments, the separator 250 can include multiple layers, with a first layer including the separator seal 255 and a second layer providing further structural fortification for the separator 250.

In some embodiments, the separator seal 255 can cover at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% of the surface area of the separator 250. In some embodiments, the separator seal 255 can cover no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10% of the surface area of the separator 250. Combinations of the above referenced percentages of the separator 250 covered by the separator seal 255 are also possible (e.g., at least about 5% and no more than about 95% or at least about 10% and no more than about 40%), inclusive of all values and ranges therebetween. In some embodiments, the separator seal 255 can cover about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the surface area of the separator 250.

In some embodiments, the separator seal 255 can cover a first percentage of a first side of the separator 250 and a second percentage of a second side of the separator 250, the second side opposite the first side. In some embodiments, the first percentage can be the same or substantially similar to the second percentage. In some embodiments, the first percentage can be different from the second percentage. In some embodiments, the first side can be adjacent to the anode 210 while the second side can be adjacent to the cathode 230.

In some embodiments, the separator seal 255 can cover at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% of the surface area of the first side of the separator 250. In some embodiments, the separator seal 255 can cover no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10% of the surface area of the first side of the separator 250. Combinations of the above referenced percentages of the first side of the separator 250 covered by the separator seal 255 are also possible (e.g., at least about 5% and no more than about 95% or at least about 10% and no more than about 40%), inclusive of all values and ranges therebetween. In some embodiments, the separator seal 255 can cover about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the surface area of the first side of the separator 250.

In some embodiments, the separator seal 255 can cover at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% of the surface area of the second side of the separator 250. In some embodiments, the separator seal 255 can cover no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10% of the surface area of the second side of the separator 250. Combinations of the above referenced percentages of the second side of the separator 250 covered by the separator seal 255 are also possible (e.g., at least about 5% and no more than about 95% or at least about 10% and no more than about 40%), inclusive of all values and ranges therebetween. In some embodiments, the separator seal 255 can cover about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the surface area of the second side of the separator 250.

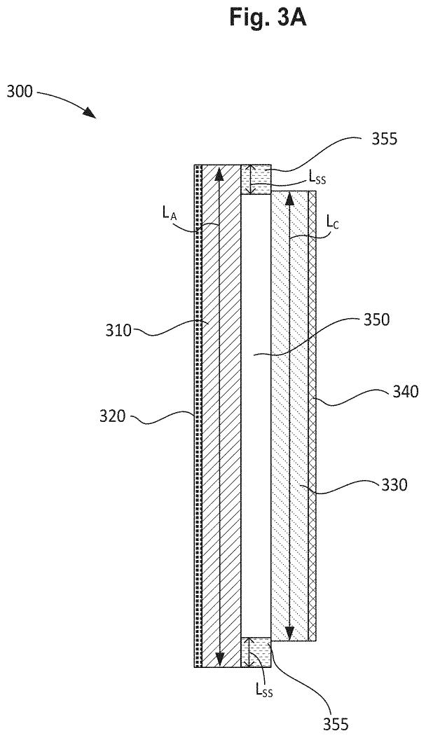

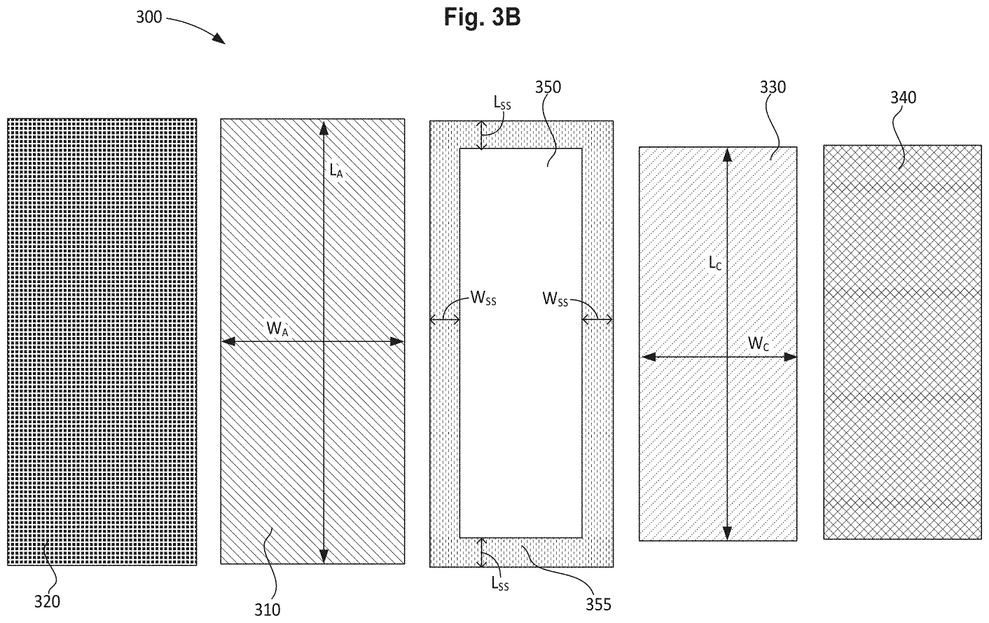

FIGS. 3A and 3B show an electrochemical cell 300, according to an embodiment. The electrochemical cell 300 includes an anode 310 disposed on an anode current collector 320, a cathode 330 disposed on a cathode current collector 340, and a separator 350 disposed between the anode 310 and the cathode 330. As shown, the separator 350 includes a separator seal 355 oriented around an outside edge of the separator 350. In some embodiments, the anode current collector 320 and/or the cathode current collector 340 can be coupled to a plastic film or pouch material (not shown). The anode 310 has an anode length L_{A} and an anode width W_{A}. The cathode 330 has a cathode length L_{C} and a cathode width W_{C}. In some embodiments, L_{A} can be greater than L_{C}. In some embodiments, L_{A} can be less than L_{C}. In some embodiments, W_{A} can be greater than W_{C}. In some embodiments, W_{A} can be less than W_{C}. In some embodiments, L_{C} can be the same or substantially similar to L_{A}. In some embodiments, W_{C} can be the same or substantially similar to W_{A}.

The separator seal 355 has a characteristic length L_{SS} and a characteristic width W_{SS}. As shown, L_{SS} describes breadth dimensions of two portions of the separator seal 355 across from one another, such that L_{SS} is oriented in the same direction as L_{A} and L_{C}. As shown, W_{SS} describes the breadth dimensions of two portions of the separator seal 355 across from one another, such that W_{SS} is oriented in the same direction as W_{A} and W_{C}. In some embodiments, L_{SS} can be greater than the difference between L_{A} and L_{C}. In some embodiments, W_{SS} can be greater than the difference between W_{A} and W_{C}. In some embodiments, L_{SS} can be the same as or substantially similar to W_{SS}. In some embodiments, L_{SS} can be different from W_{SS}.

Plating of electroactive materials around a perimeter of the electrode can occur when the dimensions of the anode 310 and the cathode 330 do not match. As shown, L_{A} is greater than L_{C} and W_{A} is greater than W_{C}. In such a cell design, as electroactive material flows from the anode 310 to the cathode 330, deposits or plates of electroactive species can develop around the outside perimeter of the cathode 330 and cathode current collector 340 on the surface of the plastic film or pouch material. The separator seal 355 is configured to restrict the flow paths of ions through the separator 350. The restriction of flow paths through the separator 350 can guide the flow path of the ions, such that the ions go into the cathode 330, and do not become deposited around the outside perimeter of the cathode 330. This can improve cyclability and capacity retention of the electrochemical cell 300, as less electroactive material is lost to this plating effect during operation of the electrochemical cell 300. The separator seal 355 can also be applied similarly when L_{A} is less than L_{C} and W_{A} is less than W_{C}. The separator seal 355 can also be applied similarly when L_{A} is the same or substantially similar to L_{C}. The separator seal 355 can also be applied similarly when W_{A} is the same or substantially similar to W_{C}.

Applying the separator seal 355 to the separator 350 to block flow through each of the edges of the anode 310 and/or the cathode 330 (i.e., the electrodes) can address the issue of decline in material quality of electrodes near the edges. If the coating quality of the electrodes is poorer at the edges of the electrodes, then blocking flow of ions near the edges of the electrodes can help prevent plating issues. This prevention of ion movement near the edges of the electrodes can be particularly relevant when heating the electrochemical cell 300 to vent gases (e.g., “hot boxing” the electrochemical cell 300), as ions can flow faster during hot boxing. In some embodiments, the application of the separator seal 355 can prevent internal short circuit events near the edge of the electrodes.

In some embodiments, the incorporation of a semi-solid electrode material into the anode 310 and/or the cathode 330 can also aid in preventing plating or internal short circuit events near the edges due. This can be due to a relatively even pressure distribution along the length and width of the semi solid electrode throughout production and operation. Evenly distributed pressure can aid in production of an evenly dispersed electrode material (i.e., uniform thickness and material concentrations) on the anode current collector 320 and/or the cathode current collector 340.

As shown, the separator seal 355 is disposed around the outside edge of the separator 350. In some embodiments, the separator seal 355 can be a tape or an adhesive material adhered to the outside surface of the separator 350. In some embodiments, the separator seal 355 can be applied to a side of the separator 350 adjacent to the anode 310. In some embodiments, the separator seal 355 can be applied to a side of the separator 350 adjacent to the cathode 330. In some embodiments, the separator seal 355 can be applied to both the anode side and the cathode side of the separator 350. In some embodiments, the separator seal 355 can be a material that permeates into the pores of portions of the separator 350, thereby blocking the flow of materials through those pores. In some embodiments, the separator seal 355 can be a polymer. In some embodiments, the separator seal 355 can be melted together with the separator 350 such that the separator 350 and the separator seal 355 are thermally bonded together. In some embodiments, the separator seal 355 can be a gel. In some embodiments, the separator seal 355 can be a high viscosity oil configured to fill pores within portions of the separator 350 and restrict the flow of electroactive material through portions of the separator 350. In some embodiments, the separator seal 355 can include a coupling between the separator 350 and the pouch material or plastic film. In other words, one side of the separator seal 355 can be in contact with the anode 310 while the opposite side of the separator seal 355 can be coupled to the pouch material or plastic film. Conversely, one side of the separator seal 355 can be in contact with the cathode 330 while the opposite side of the separator seal 355 can be coupled to the pouch material or plastic film.

In some embodiments, the separator seal 355 can have the same or a substantially similar melting temperature to the separator 350 or the portion of the separator 350 that does not include the separator seal 355. In some embodiments, the separator seal 355 can have a higher melting temperature than the separator 350 or the portion of the separator 350 that does not include the separator seal 355. In some embodiments, the separator seal 355 can have a melting temperature that is higher than the melting temperature of the separator 350 or the portion of the separator 350 that does not include the separator seal 355 by at least about 5° C., at least about 10° C., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., or at least about 95° C. In some embodiments, the separator seal 355 can have a melting temperature that is higher than the melting temperature of the separator 350 or the portion of the separator 350 that does not include the separator seal 355 by no more than about 100° C., no more than about 95° C., no more than about 90° C., no more than about 85° C., no more than about 80° C., no more than about 75° C., no more than about 70° C., no more than about 65° C., no more than about 60° C., no more than about 55° C., no more than about 50° C., no more than about 45° C., no more than about 40° C., no more than about 35° C., no more than about 30° C., no more than about 25° C., no more than about 20° C., no more than about 15° C., or no more than about 10° C. Combinations of the above-referenced differences between the melting temperature of the separator seal 355 and the separator 350 or the portion of the separator 350 that does not include the separator seal 355 are also possible (e.g., at least about 5° C. and no more than about 100° C. or at least about 40° C. and no more than about 60° C.), inclusive of all values and ranges therebetween. In some embodiments, the separator seal 355 can have a melting temperature that is higher than the melting temperature of the separator 350 or the portion of the separator 350 that does not include the separator seal 355 by at about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C.

In some embodiments, the separator seal 355 can have a melting temperature that is lower than the melting temperature of the separator 350 or the portion of the separator 350 that does not include the separator seal 355 by at least about 5° C., at least about 10° C., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., or at least about 95° C. In some embodiments, the separator seal 355 can have a melting temperature that is lower than the melting temperature of the separator 350 or the portion of the separator 350 that does not include the separator seal 355 by no more than about 100° C., no more than about 95° C., no more than about 90° C., no more than about 85° C., no more than about 80° C., no more than about 75° C., no more than about 70° C., no more than about 65° C., no more than about 60° C., no more than about 55° C., no more than about 50° C., no more than about 45° C., no more than about 40° C., no more than about 35° C., no more than about 30° C., no more than about 25° C., no more than about 20° C., no more than about 15° C., or no more than about 10° C. Combinations of the above-referenced differences between the melting temperature of the separator seal 355 and the separator 350 or the portion of the separator 350 that does not include the separator seal 355 are also possible (e.g., at least about 5° C. and no more than about 100° C. or at least about 40° C. and no more than about 60° C.), inclusive of all values and ranges therebetween. In some embodiments, the separator seal 355 can have a melting temperature that is lower than the melting temperature of the separator 350 or the portion of the separator 350 that does not include the separator seal 355 by at about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C.

In some embodiments, the difference in length between the anode 310 and the cathode 330 (|L_{A}−L_{C}|) can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (|L_{A}−L_{C}|) can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (|L_{A}−L_{C}|) (e.g., at least about 1 μm and no more than about 10 cm or at least about 10 mm and no more than about 1 cm), inclusive of all values and ranges therebetween. In some embodiments, (|L_{A}−L_{C}|) can be about 1 μm, about 5 μm, about 10 μm, about 50 μm, about 100 μm, about 500 μm, about 1 mm, about 5 mm, about 1 cm, about 5 cm, or about 10 cm.

In some embodiments, the difference in width between the anode 310 and the cathode 330 (|W_{A}−W_{C}|) can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (|W_{A}−W_{C}|) can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (|W_{A}−W_{C}|) (e.g., at least about 1 μm and no more than about 10 cm or at least about 10 mm and no more than about 1 cm), inclusive of all values and ranges therebetween. In some embodiments, (|W_{A}−W_{C}|) can be about 1 μm, about 5 μm, about 10 μm, about 50 μm, about 100 μm, about 500 μm, about 1 mm, about 5 mm, about 1 cm, about 5 cm, or about 10 cm.

In some embodiments, the L_{SS} can be greater than (|L_{A}−L_{C}|. In some embodiments, (L_{SS}−|L_{A}−L_{C}| can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (L_{SS}−|L_{A}−L_{C}| can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (L_{SS}−|L_{A}−L_{C}| (e.g., at least about 1 μm and no more than about 10 cm or at least about 10 mm and no more than about 1 cm, inclusive of all values and ranges therebetween. In some embodiments, (L_{SS}−|L_{A}−L_{C}| can be about 1 μm, about 5 μm, about 10 μm, about 50 μm, about 100 μm, about 500 μm, about 1 mm, about 5 mm, about 1 cm, about 5 cm, or about 10 cm.

In some embodiments, the W_{SS} can be greater than (|W_{A}−W_{C}|. In some embodiments, (W_{SS}−|W_{A}−W_{C}| can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (W_{SS}−|W_{A}−W_{C}| can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (W_{SS}−|W_{A}−W_{C}| (e.g., at least about 1 μm and no more than about 10 cm or at least about 10 mm and no more than about 1 cm, inclusive of all values and ranges therebetween. In some embodiments, (W_{SS}−|W_{A}−W_{C}| can be about 1 μm, about 5 μm, about 10 μm, about 50 μm, about 100 μm, about 500 μm, about 1 mm, about 5 mm, about 1 cm, about 5 cm, or about 10 cm.

In some embodiments, the separator seal 355 can be employed in an electrochemical cell incorporated into a stacked configuration (i.e., an electrochemical cell stack. In some embodiments, the separator seal 355 can include a degassing port (not shown. In some embodiments, the separator seal 355 can have a degassing port fluidically coupled to the anode 310, configured to vent gas from the anode 310 to the exterior of the electrochemical cell 300 through the separator seal 355. In some embodiments, the separator seal 355 can have a degassing port fluidically coupled to the cathode 330, configured to vent gas from the cathode 330 to the exterior of the electrochemical cell 300 through the separator seal. In some embodiments, the separator seal can include both a degassing port fluidically coupled to the anode 310 and a degassing port fluidically coupled to the cathode 330.

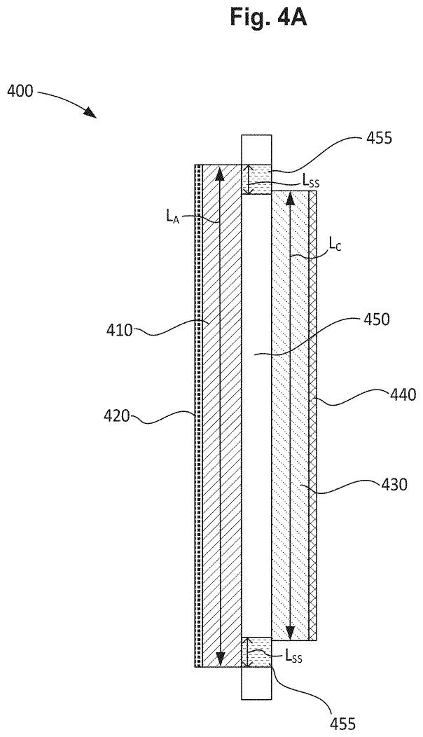

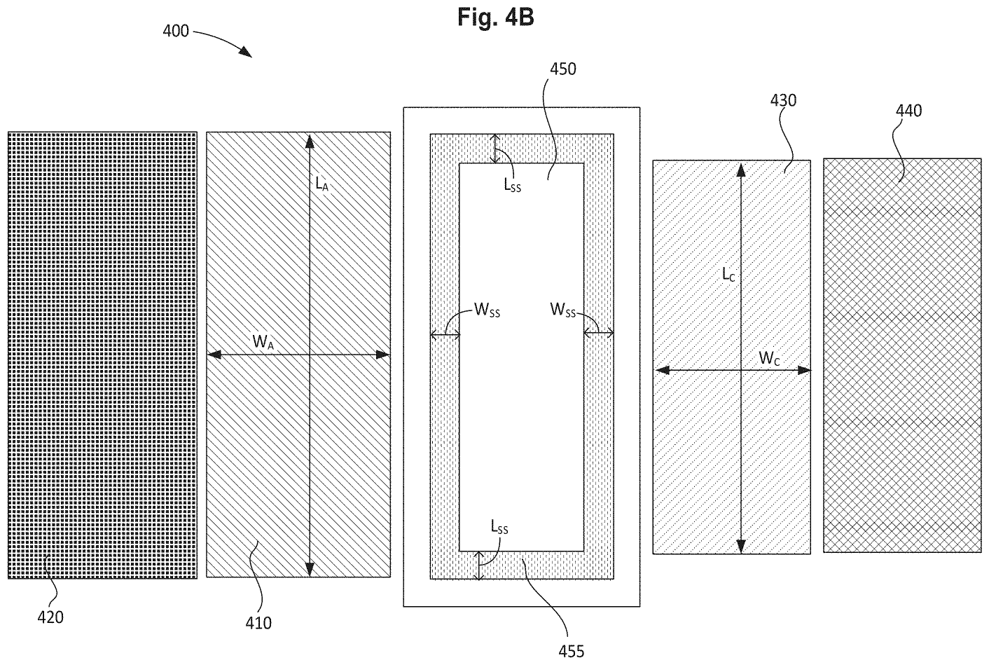

FIGS. 4A and 4B show an electrochemical cell 400, according to an embodiment. The electrochemical cell 400 includes an anode 410 disposed on an anode current collector 420, a cathode 430 disposed on a cathode current collector 440, and a separator 450 disposed between the anode 410 and the cathode 430. As shown, the separator 450 includes a separator seal 455. In some embodiments, the anode current collector 420 and/or the cathode current collector 440 can be coupled to a plastic film or pouch material (not shown). The anode 410 has an anode length L_{A} and an anode width W_{A}. The cathode 430 has a cathode length L_{C} and a cathode width W_{C}. In some embodiments, L_{A} can be greater than L_{C}. In some embodiments, L_{A} can be less than L_{C}. In some embodiments, W_{A} can be greater than W_{C}. In some embodiments, W_{A} can be less than W_{C}. In some embodiments, L_{C} can be the same or substantially similar to L_{A}. In some embodiments, W_{C} can be the same or substantially similar to W_{A}. In some embodiments, the separator seal 455 can have the same or substantially similar physical properties to the separator seal 355, as described above with reference to FIG. 3, including the degassing port or degassing ports.

The separator seal 455 has a characteristic length L_{SS} and a characteristic width W_{SS}. As shown, L_{SS} describes breadth dimensions of two portions of the separator seal 455 across from one another, such that L_{SS} is oriented in the same direction as L_{A} and L_{C}. As shown, W_{SS} describes the breadth dimensions of two portions of the separator seal 455 across from one another, such that W_{SS} is oriented in the same direction as W_{A} and W_{C}. In some embodiments, L_{SS} can be greater than the difference between L_{A} and L_{C}. In some embodiments, W_{SS} can be greater than the difference between W_{A} and W_{C}. In some embodiments, L_{SS} can be the same as or substantially similar to W_{SS}. In some embodiments, L_{SS} can be different from W_{SS}.

As shown, the separator 450 extends beyond the length and width dimensions of both the anode 410 and the cathode 430. In other words, the separator seal 455 does not extend to the edge of the separator 450. In some embodiments, the separator 450 can be coupled to a plastic film or pouch material (not shown). In some embodiments, both sides of the separator seal 455 can include a portion that is coupled to the pouch material or plastic film. In other words, the separator seal 455 can both restrict the flow of electroactive materials and provide a seal between the separator 450 and the pouch material or plastic film on the anode side and/or the cathode side of the electrochemical cell 400. In some embodiments, the separator seal 455 can extend to the edge of the separator 450.

In some embodiments, the difference in length between the anode 410 and the cathode 430 (|L_{A}−L_{C}| can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (|L_{A}−L_{C}| can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (|L_{A}−L_{C}| (e.g., at least about 1 μm and no more than about 10 cm or at least about 10 mm and no more than about 1 cm, inclusive of all values and ranges therebetween. In some embodiments, (|L_{A}−L_{C}| can be about 1 μm, about 5 μm, about 10 μm, about 50 μm, about 100 μm, about 500 μm, about 1 mm, about 5 mm, about 1 cm, about 5 cm, or about 10 cm.

In some embodiments, the difference in width between the anode 410 and the cathode 430 (|W_{A}−W_{C}| can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (|W_{A}−W_{C}| can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (|W_{A}−W_{C}| (e.g., at least about 1 μm and no more than about 10 cm or at least about 10 mm and no more than about 1 cm, inclusive of all values and ranges therebetween. In some embodiments, (|W_{A}−W_{C}| can be about 1 μm, about 5 μm, about 10 μm, about 50 μm, about 100 μm, about 500 μm, about 1 mm, about 5 mm, about 1 cm, about 5 cm, or about 10 cm.

In some embodiments, L_{SS} can be greater than (|L_{A}−L_{C}|. In some embodiments, (L_{SS}−|L_{A}−L_{C}| can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (L_{SS}−|L_{A}−L_{C}| can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (L_{SS}−|L_{A}−L_{C}| (e.g., at least about 1 μm and no more than about 10 cm or at least about 10 mm and no more than about 1 cm, inclusive of all values and ranges therebetween. In some embodiments, (L_{SS}−|L_{A}−L_{C}|) can be about 1 μm, about 5 μm, about 10 μm, about 50 μm, about 100 μm, about 500 μm, about 1 mm, about 5 mm, about 1 cm, about 5 cm, or about 10 cm.

In some embodiments, the W_{SS} can be greater than (|W_{A}−W_{C}|). In some embodiments, (W_{SS}−|W_{A}−W_{C}|) can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (W_{SS}−|W_{A}−W_{C}|) can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (W_{SS}−|W_{A}−W_{C}|) (e.g., at least about 1 μm and no more than about 10 cm or at least about 10 mm and no more than about 1 cm), inclusive of all values and ranges therebetween. In some embodiments, (W_{SS}−|W_{A}−W_{C}|) can be about 1 μm, about 5 μm, about 10 μm, about 50 μm, about 100 μm, about 500 μm, about 1 mm, about 5 mm, about 1 cm, about 5 cm, or about 10 cm.

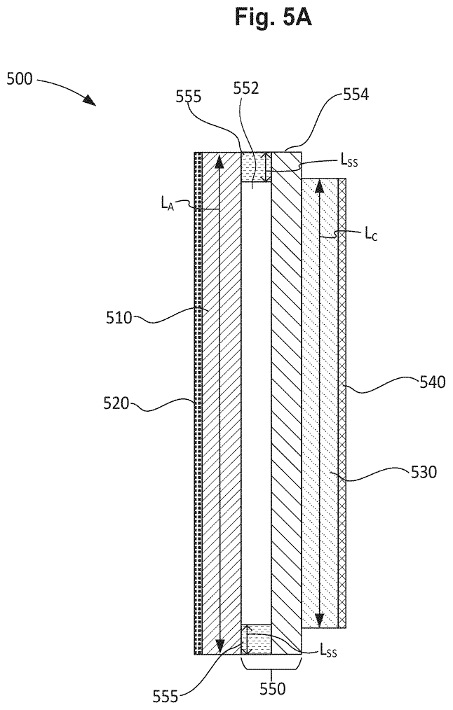

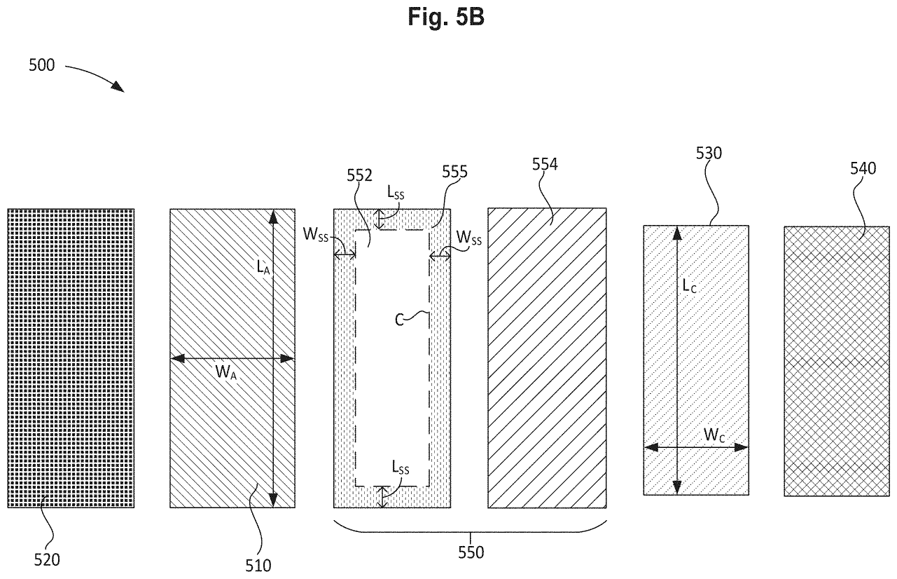

FIGS. 5A and 5B show an electrochemical cell 500, according to an embodiment. The electrochemical cell 500 includes an anode 510 disposed on an anode current collector 520, a cathode 530 disposed on a cathode current collector 540, and a separator 550 disposed between the anode 510 and the cathode 530. As shown, the separator 550 includes a first layer 552 and a second layer 554. As shown, the first layer 552 includes a separator seal 555 with a boundary line C depicted as a dotted line marking the interface between the separator seal 555 and the remaining area of the first layer 552. In some embodiments, the anode current collector 520 and/or the cathode current collector 540 can be coupled to a plastic film or pouch material (not shown). The anode 510 has an anode length L_{A} and an anode width W_{A}. The cathode 530 has a cathode length L_{C} and a cathode width W_{C}. In some embodiments, L_{A} can be greater than L_{C}. In some embodiments, L_{A} can be less than L_{C}. In some embodiments, W_{A} can be greater than W_{C}. In some embodiments, W_{A} can be less than W_{C}. In some embodiments, the separator seal 555 can have the same or substantially similar physical properties to the separator seal 355, as described above with reference to FIG. 3, including the degassing port or degassing ports.

The separator seal 555 has a characteristic length L_{SS} and a characteristic width W_{SS}. As shown, L_{SS} describes breadth dimensions of two portions of the separator seal 555 across from one another, such that L_{SS} is oriented in the same direction as L_{A} and L_{C}. As shown, W_{SS} describes the breadth dimensions of two portions of the separator seal 555 across from one another, such that W_{SS} is oriented in the same direction as W_{A} and W_{C}. In some embodiments, L_{SS} can be greater than the difference between L_{A} and L_{C}. In some embodiments, W_{SS} can be greater than the difference between W_{A} and W_{C}. In some embodiments, L_{SS} can be the same as or substantially similar to W_{SS}. In some embodiments, L_{SS} can be different from W_{SS}.

In some embodiments, the anode 510, the anode current collector 520, the cathode 530, and the cathode current collector 540 can be the same or substantially similar to the anode 210, the anode current collector 220, the cathode 230, and the cathode current collector 240, as described above with reference to FIG. 2. Thus, certain aspects of the anode 510, the anode current collector 520, the cathode 530, and the cathode current collector 540 are not described in further detail herein. In some embodiments, L_{A}, L_{C}, W_{A}, W_{C}, L_{A}, and W_{SS} can be the same or substantially similar to L_{A}, L_{C}, W_{A}, W_{C}, L_{A}, L_{SS}, and W_{SS}, as described above with reference to FIG. 3. Thus certain aspects of L_{A}, L_{C}, W_{A}, W_{C}, L_{A}, L_{SS}, and W_{SS} are not described in greater detail herein.

As shown, the separator 550 is a dual layer separator. In some embodiments, the first layer 552 can be coupled to the second layer 554 via an adhesive, a tape, heat sealing, or any other suitable coupling means or combinations thereof. In some embodiments, application of heat to form the separator seal 555 cause heat damage to the regions of the first layer 552 that make up the separator seal 555. In some embodiments, the regions of the first layer 552 that make up the separator seal 555 can peel away. In some embodiments, cracks can develop along the boundary line C, or elsewhere on the first layer 552 or separator seal 555. When cracks or other damage develop on the first layer 552, electroactive material (e.g., the anode 510, the cathode 530) can potentially leak through the first layer 552. The inclusion of the second layer 554 of the separator 550 can further fortify the separator 550, such that cracks or damage that develop on the first layer 552 do not lead to short circuit events (i.e., from contact between anode 510 and cathode 530) or leaking of electroactive materials.

In some embodiments, the second layer 554 can be composed of a different material from the first layer 552. In some embodiments, the second layer 554 can be composed of a material with a higher melting temperature than the material that makes up the first layer 552. In some embodiments, the second layer 554 can have greater heat resistance (i.e., a greater resistance to heat damage) than the first layer 552. In some embodiments, the first layer 552 can be composed of polyethylene. In some embodiments, the second layer 554 can be composed of polypropylene. In some embodiments, the first layer 552 and/or the second layer 554 can be composed of polyethylene, polypropylene, high density polyethylene, polyethylene terephthalate, polystyrene, a thermosetting polymer, hard carbon, a thermosetting resin, a polyimide, a ceramic coated separator, an inorganic separator, cellulose, glass fiber, or any other suitable material, or combinations thereof. In some embodiments, a first side of the first layer 552 can be coated with a ceramic and a second side of the first layer 552 can be sealed to the second layer 554, the second side opposite the first side. In some embodiments, an additional layer of material (not shown) can be coated on the first layer 552. In some embodiments, the additional layer of material can be opposite the second layer 554. In some embodiments, the additional layer can include a polymer of intrinsic microporosity (PIM). In some embodiments, the additional layer can include polypropylene. In some embodiments, the first layer 552 can have a high melting point (e.g., if the first layer 552 is composed of polyimide, glass fiber, etc.), such that melting a portion of the first layer 552 to form the separator seal 555 is impractical. In some embodiments, a portion of the first layer 552 can be mechanically pressed to close pores on the first layer 552 and create the separator seal 555.

In some embodiments, the second layer 554 can have a higher melting temperature than the first layer 552. In some embodiments, the melting temperature of the second layer 554 can be greater than the melting temperature of the first layer 552 by at least about 5° C., at least about 10° C., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., or at least about 95° C. In some embodiments, the melting temperature of the second layer 554 can be greater than the melting temperature of the first layer 552 by no more than about 100° C., no more than about 95° C., no more than about 90° C., no more than about 85° C., no more than about 80° C., no more than about 75° C., no more than about 70° C., no more than about 65° C., no more than about 60° C., no more than about 55° C., no more than about 50° C., no more than about 45° C., no more than about 40° C., no more than about 35° C., no more than about 30° C., no more than about 25° C., no more than about 20° C., no more than about 15° C., or no more than about 10° C. Combinations of the above-referenced differences between the melting temperature of the second layer 554 and melting temperature of the first layer 552 are also possible (e.g., at least about 5° C. and no more than about 100° C. or at least about 40° C. and no more than about 60° C.), inclusive of all values and ranges therebetween. In some embodiments, the melting temperature of the second layer 554 can be greater than the melting temperature of the first layer 552 by at about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C.

In some embodiments, portions of the first layer 552 can be selectively melted to the second layer 554 to form the separator seal 555. In other words, the selectively melted portions of the first layer 552 can bond to the second layer 554. For example, if the first layer 552 is composed of polyethylene and the second layer 554 is composed of polypropylene, portions of the polyethylene layer can be melted and bonded to the polypropylene layer. In some embodiments, an outside edge of the first layer 552 can be melted to the second layer 554 to form the separator seal 555. In some embodiments, portions of the first layer 552 and portions of the second layer 554 can be selectively melted to form the separator seal 555. In some embodiments, portions of the first layer 552 and portions of the second layer 554 can be selectively melted and bonded together to form the separator seal 555. In some embodiments, the outside edge of the first layer 552 and an outside edge of the second layer 554 can be melted together to form the separator seal 555.

As shown, the portion of the separator 550 that includes the separator seal 555 (i.e., the first layer 552) is on the side of the electrochemical cell 500 adjacent to the anode 510. In some embodiments, the first layer 552 can be adjacent to the cathode 530. As shown, the portion of the separator 550 that fortifies the separator 550 (i.e., the second layer 554) is on the side of the electrochemical cell 500 adjacent to the cathode 530. In some embodiments, the second layer 554 can be on the side of the electrochemical cell 500 adjacent to the anode 510.

As shown, the separator 550 has similar length and width dimensions to the anode 510. In other words, the outside edges of the separator 550 and the outside edges of the separator seal 555 are shown as approximately flush with the outside edges of the anode 510. In some embodiments, the separator 550 can extend beyond the length and width dimensions of both the anode 510 and the cathode 530, similar to the separator 450, as described above with reference to FIG. 4. In some embodiments, the separator seal 555 does not extend to the edge of the separator 550. In some embodiments, the separator 550 can be coupled to a plastic film or pouch material (not shown). In some embodiments, both sides of the separator seal 555 can include a portion that is coupled to the pouch material or plastic film. In other words, the separator seal 555 can both restrict the flow of electroactive materials and provide a seal between the separator 550 and the pouch material or plastic film on the anode side and/or the cathode side of the electrochemical cell 500. In some embodiments, the separator seal 555 can extend to the edge of the separator 550 while the separator 550 extends beyond the edges of the anode 510.

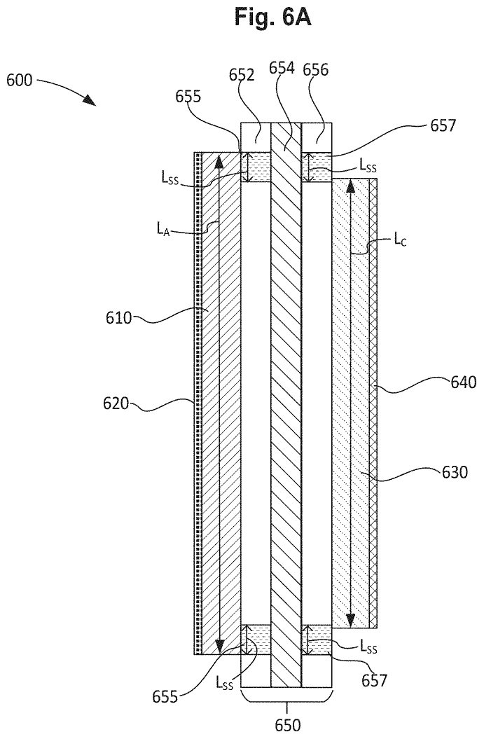

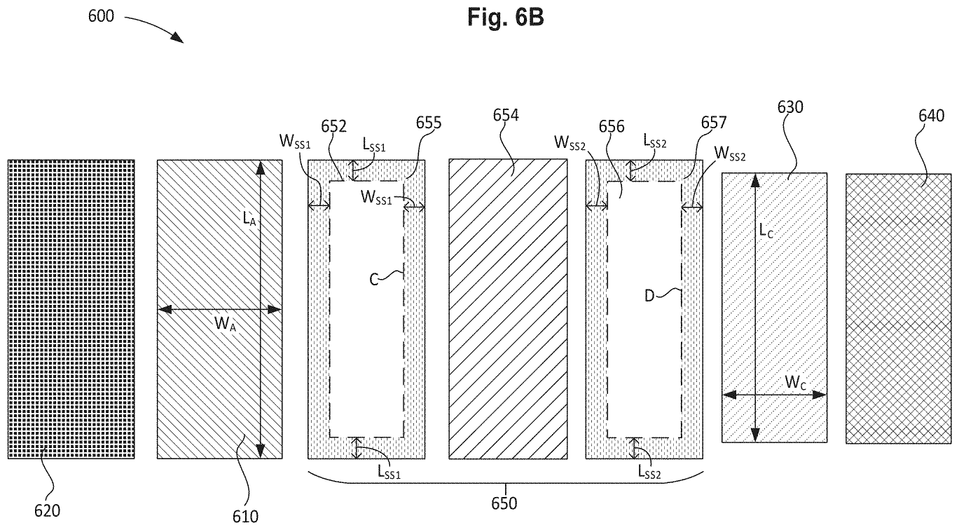

FIGS. 6A and 6B show an electrochemical cell 600, according to an embodiment. The electrochemical cell 600 includes an anode 610 disposed on an anode current collector 620, a cathode 630 disposed on a cathode current collector 640, and a separator 650 disposed between the anode 610 and the cathode 630. As shown, the separator 650 includes a first layer 652, a second layer 654, and a third layer 656. As shown, the first layer 652 includes a separator seal 655 with a boundary line C depicted as a dotted line marking the interface between the separator seal 655 and the remaining area of the first layer 652. As shown, the third layer 656 includes a separator seal 657 with a boundary line D depicted as a dotted line marking the interface between the separator seal 657 and the remaining area of the third layer 657. In some embodiments, the anode current collector 620 and/or the cathode current collector 640 can be coupled to a plastic film or pouch material (not shown). The anode 610 has an anode length L_{A} and an anode width W_{A}. The cathode 630 has a cathode length L_{C} and a cathode width W_{C}. In some embodiments, L_{A} can be greater than L_{C}. In some embodiments, L_{A} can be less than L_{C}. In some embodiments, W_{A} can be greater than W_{C}. In some embodiments, W_{A} can be less than W_{C}. In some embodiments, the separator seal 655 and/or the separator seal 657 can have the same or substantially similar physical properties to the separator seal 355, as described above with reference to FIG. 3, including the degassing port or degassing ports.

The separator seal 655 has a characteristic length L_{SS1} and a characteristic width W_{SS1}. As shown, L_{SS1} describes breadth dimensions of two portions of the separator seal 655 across from one another, such that L_{SS1} is oriented in the same direction as L_{A} and L_{C}. As shown, W_{SS1} describes the breadth dimensions of two portions of the separator seal 655 across from one another, such that W_{SS1} is oriented in the same direction as W_{A} and W_{C}. In some embodiments, L_{SS1} can be greater than the difference between L_{A} and L_{C}. In some embodiments, W_{SS1} can be greater than the difference between W_{A} and W_{C}. In some embodiments, L_{SS1} can be the same as or substantially similar to W_{SS1}. In some embodiments, L_{SS1} can be different from W_{SS1}.

The separator seal 657 has a characteristic length L_{SS2} and a characteristic width W_{SS2}. As shown, L_{SS2} describes breadth dimensions of two portions of the separator seal 657 across from one another, such that L_{SS2} is oriented in the same direction as L_{A} and L_{C}. As shown, W_{SS2} describes the breadth dimensions of two portions of the separator seal 657 across from one another, such that W_{SS2} is oriented in the same direction as W_{A} and W_{C}. In some embodiments, L_{SS2} can be greater than the difference between L_{A} and L_{C}. In some embodiments, W_{SS2} can be greater than the difference between W_{A} and W_{C}. In some embodiments, L_{SS2} can be the same as or substantially similar to W_{SS2}. In some embodiments, L_{SS1} can be different from W_{SS2}.

In some embodiments, the separator seal 655 can be the same or substantially similar to the separator seal 657. In some embodiments, the separator seal 655 can be different from the separator seal 657. In some embodiments, L_{SS1} can be the same or substantially similar to L_{SS2}. In some embodiments, L_{SS1} can be different from L_{SS2}. In some embodiments, W_{SS1} can be the same or substantially similar to W_{SS2}. In some embodiments, W_{SS1} can be different from W_{SS2}.

In some embodiments, the anode 610, the anode current collector 620, the cathode 630, and the cathode current collector 640 can be the same or substantially similar to the anode 210, the anode current collector 220, the cathode 230, and the cathode current collector 240, as described above with reference to FIG. 2. Thus, certain aspects of the anode 610, the anode current collector 620, the cathode 630, and the cathode current collector 640 are not described in further detail herein. In some embodiments, L_{A}, L_{C}, W_{A}, W_{C}, and L_{A} can be the same or substantially similar to L_{A}, L_{C}, W_{A}, W_{C}, and L_{A} as described above with reference to FIG. 3. In some embodiments, L_{SS1} and W_{SS1} can be the same or substantially similar to L_{SS} and W_{SS}, as described above with reference to FIG. 3. In some embodiments, L_{SS2} and W_{SS2} can be the same or substantially similar to L_{SS} and W_{SS}, as described above with reference to FIG. 3. Thus, certain aspects of L_{A}, L_{C}, W_{A}, W_{C}, L_{A}, L_{SS1}, L_{SS2}, W_{SS1}, and W_{SS2} are not described in greater detail herein.

As shown, the separator 650 is a tri-layer separator. In some embodiments, the first layer 652 can be bonded to the second separator 654 and/or the third layer 656 can be bonded to the second separator 654 via an adhesive, a tape, heat sealing, or any other suitable coupling means or combinations thereof. Similar to the separator seal 555, as described above with reference to FIG. 5, application of heat to form the separator seal 655 or the separator seal 657 can cause heat damage to the regions of the first layer 652 or the third layer 656 that make up the separator seal 655 or the separator seal 657. The inclusion of the second layer 654 can further fortify the separator 650 to prevent leaking of electroactive material or short circuits. In some embodiments, the first layer 652 can be the same or substantially similar to the first layer 552, as described above with reference to FIG. 5. In some embodiments, the third layer 656 can be the same or substantially similar to the first layer 552, as described above with reference to FIG. 5. In some embodiments, the second layer 654 can be the same or substantially similar to the second layer 554, as described above with reference to FIG. 5. In some embodiments, the separator seal 655 can be the same or substantially similar to the separator seal 555, as described above with reference to FIG. 5. In some embodiments, the separator seal 657 can be the same or substantially similar to the separator seal 555, as described above with reference to FIG. 5. Thus, certain aspects of the first layer 652, the second layer 654, the third layer 656, the separator seal 655, and the separator seal 657 are not described in greater detail herein.

In some embodiments, the first layer 652 can be the same or substantially similar to the third layer 656. In some embodiments, the first layer 652 can be different from the third layer 656. For example, the first layer 652 can differ in thickness and/or composition, compared to the third layer 656. In some embodiments, the separator seal 655 can be the same or substantially similar to the separator seal 657. In some embodiments, the separator seal 655 can be different from the separator seal 657. In some embodiments, the separator seal 655 can be implemented via a first mechanism and the separator seal 657 can be implemented via a second mechanism. For example, the separator seal 655 can be implemented via heat sealing while the separator seal 657 can be implemented via adhesive. In some embodiments, W_{SS1} can be the same or substantially similar to W_{SS2}. In some embodiments, W_{SS1} can be different from W_{SS2}. In some embodiments, L_{SS1} can be the same or substantially similar to L_{SS2}. In some embodiments, L_{SS1} can be different from W_{SS2}.

As shown, the separator 650 includes three layers. In some embodiments, the separator 650 can include 4, 5, 6, 7, 8, 9, 10, 11, 12, 13, 14, 15, 16, 17, 18, 19, 20, or at least about 20 layers, inclusive of all values and ranges therebetween. In some embodiments, the separator 650 can include an assembly that alternate between layers with a separator seal portion (e.g., the first layer 652, the third layer 656) and layers without a separator seal portion (e.g., the second layer 654). In some embodiments, the separator 650 can include multiple layers with a separator seal portion coupled together in sequence and/or multiple layers without a separator seal portion coupled together in sequence.

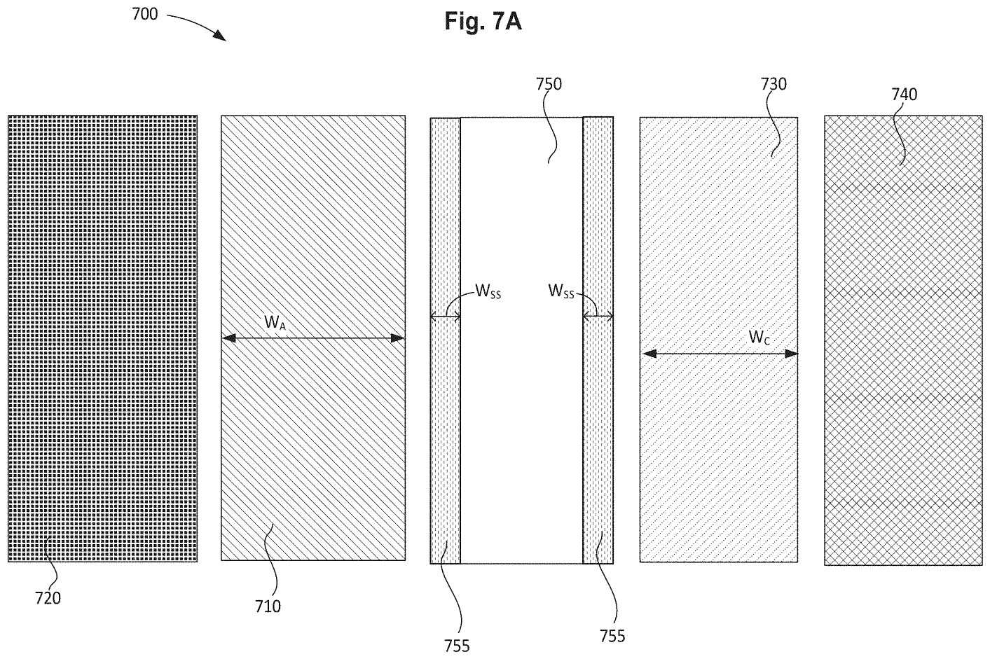

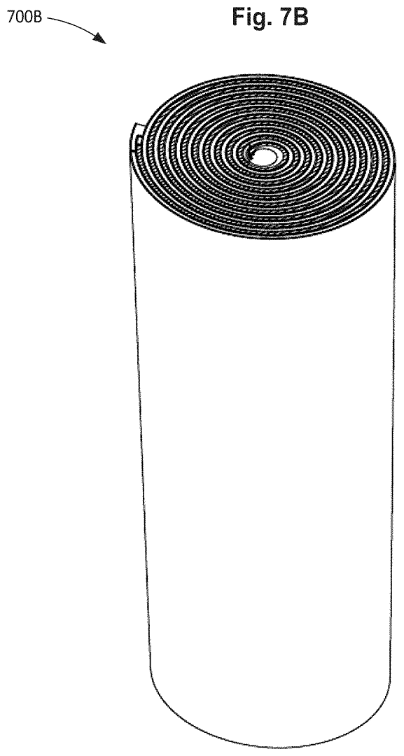

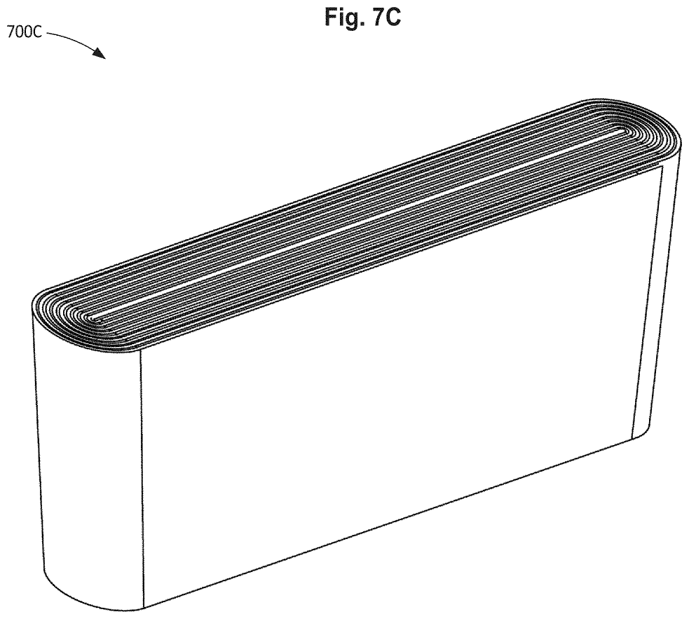

FIGS. 7A-7C show a wound electrochemical cell 700, according to an embodiment. FIG. 7A shows the components of the wound electrochemical cell 700 in a deconstructed state. FIG. 7B shows the wound electrochemical cell 700 formed into the cylindrical cell 700B. FIG. 7C shows the wound electrochemical cell 700 formed into a prismatic cell 700C. The wound electrochemical cell 700 includes an anode 710 disposed on an anode current collector 720, a cathode 730 disposed on a cathode current collector 740, and a separator 750 disposed between the anode 710 and the cathode 730. As shown, the separator 750 includes a separator seal 755. In some embodiments, the anode current collector 720 and/or the cathode current collector 740 can be coupled to a plastic film or pouch material (not shown). The anode 710 has an anode width W_{A}. The cathode 730 has a cathode width W_{C}. In some embodiments, W_{A} can be greater than W_{C}. In some embodiments, W_{A} can be less than W_{C}. The separator seal 755 has a width W_{SS}. In some embodiments, the anode 710, the anode current collector 720, the cathode 730, the cathode current collector 740, the separator 750, the separator seal 755, W_{A}, W_{C}, and W_{SS} can have the same or substantially similar properties to the anode 310, the anode current collector 320, the cathode 330, the cathode current collector 340, the separator 350, the separator seal 355, W_{A}, W_{C}, and W_{SS} as described above with reference to FIGS. 3A-3B. Thus, certain aspects of the anode 710, the anode current collector 720, the cathode 730, the cathode current collector 740, the separator 750, and the separator seal 755 are not described in greater detail herein.

In some embodiments, the separator seal 755 can be manufactured such that the separator seal 755 is only on two edges of the separator 750 rather than four edges of the separator 750. In some embodiments, the separator 750 can be manufactured continuously as one long piece of material. In some embodiments, the separator 750 can be manufactured with the separator seal 755 included. In some embodiments, the separator seal 755 can be incorporated into the separator 750 after the separator 750 is manufactured. In some embodiments, the anode 710 and/or the cathode 730 can be coupled to the separator 750. In some embodiments, the anode 710 and/or the cathode 730 can be coupled to the separator 750 via an adhesive. In some embodiments, coupling the anode 710 and/or the cathode 730 to the separator 750 can aid in avoiding misalignment while winding the wound electrochemical cell 700 to form the cylindrical cell 700B or the prismatic cell 700C.

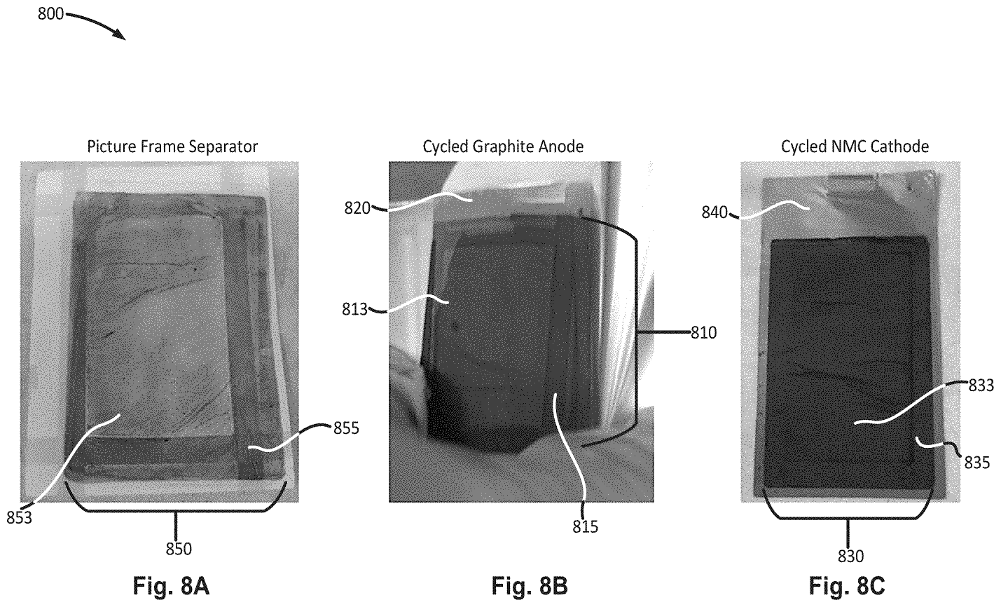

FIG. 8 shows an illustration of a deconstructed electrochemical cell 800, according to an embodiment. Visible in this depiction are an anode 810, an anode current collector 820, a cathode 830, a cathode current collector 840, and a separator 850 with a permeable region 853 and a separator seal 855. The separator seal 855 is a frame member disposed around the outside of the separator 850. Pores around the edge of the separator 850 are sealed via application of heat to selectively melt a portion of the separator 850 and prevent transportation of lithium ions during operation of the electrochemical cell 800. The anode 810 is a graphite anode while the cathode 830 is an NMC cathode. After initial cycling, an inner region 813 and a frame region 815 are visible on the anode 810, indicating where ion flow was blocked during initial cycling. The inner region 813 includes lithiated graphite having an appearance gold in color, while non-lithiated graphite in the frame region 815 appears black. An inner region 833 and a frame region 835 are also visible on the cathode 830, where the frame region 835 indicates where ion flow was blocked during initial cycling.

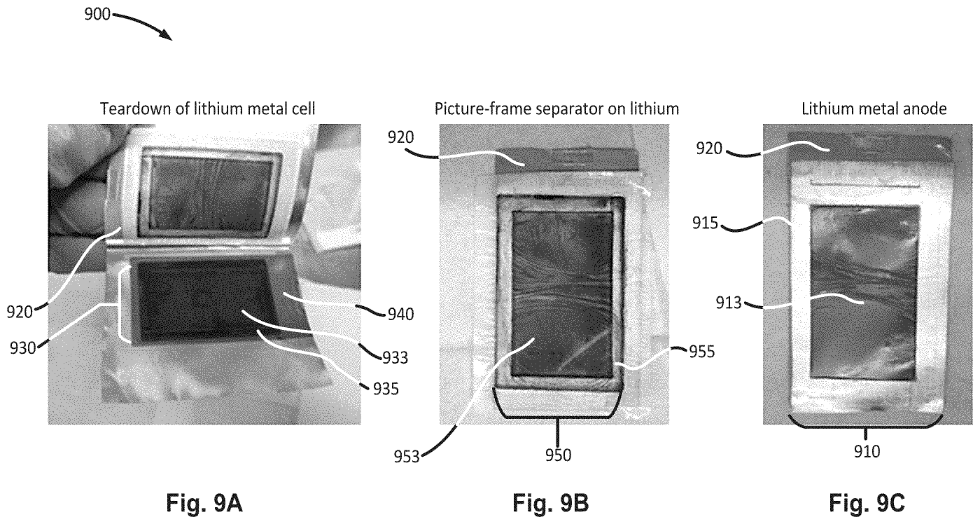

FIG. 9 shows an illustration of a deconstructed electrochemical cell 900, according to an embodiment. Visible in this depiction are an anode 910, an anode current collector 920, a cathode 930, a cathode current collector 940, and a separator 950 with a permeable region 953 and a separator seal 955. The anode 920 is a lithium metal anode. The separator seal 955 is a framing member disposed around the outside of the separator 950. Pores around the edge of the separator 950 are sealed via application of heat to selectively melt a portion of the separator 950 and prevent transportation of lithium ions during operation of the electrochemical cell 900. After initial cycling, an inner region 913 and a frame region 915 are visible on the anode 910, indicating where ion flow was blocked during initial cycling. The inner region includes 913 has a dark appearance, as the inner region 913 has been plated by NMC from the cathode 930, and solid-electrolyte interface (SEI) formation makes the electrode surface appear dark. The frame region 915 still appears as the color of lithium, as NMC from the cathode 930 was substantially prevented from contacting the frame region. Similarly, the permeable region 953 of the separator 950 has a darker appearance, due to contact with NMC. An inner region 933 and a frame region 935 are also visible on the cathode 930, where the frame region 935 indicates where ion flow was blocked during initial cycling.

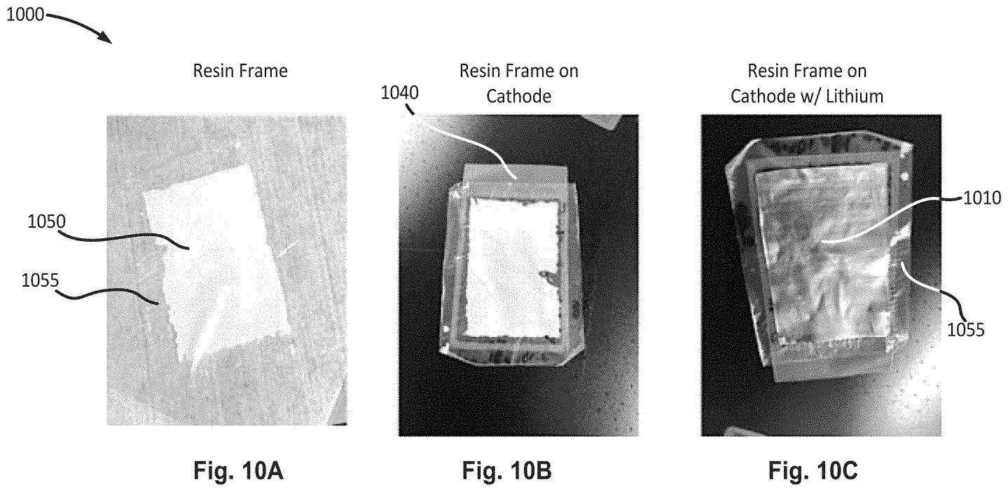

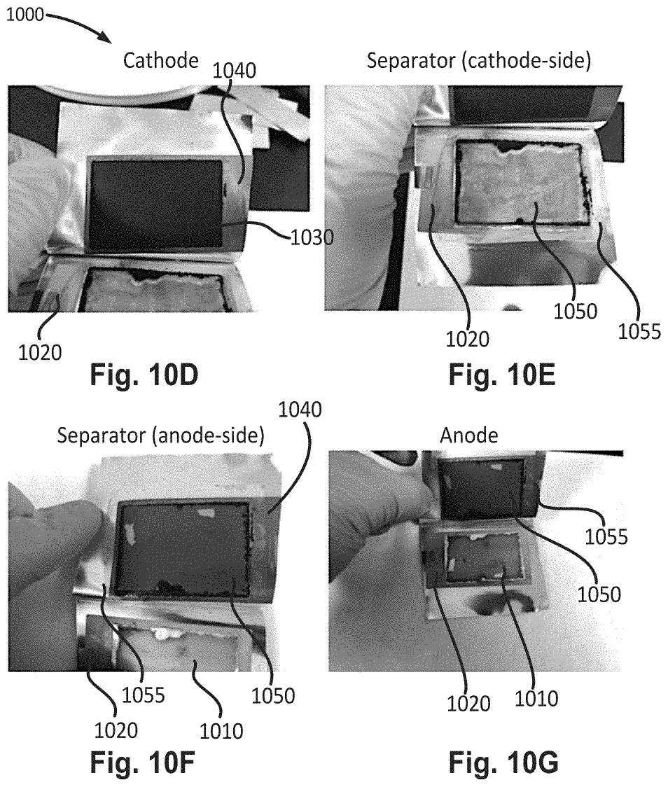

FIG. 10 shows an illustration of a deconstructed electrochemical cell 1000, according to an embodiment. Visible in this depiction are an anode 1010, an anode current collector 1020, a cathode 1030, a cathode current collector 1040, and a separator 1050 with a separator seal 1055. The anode 1020 is a lithium metal anode. The separator seal 1055 is a resin framing member disposed around the outside of the separator 1050.

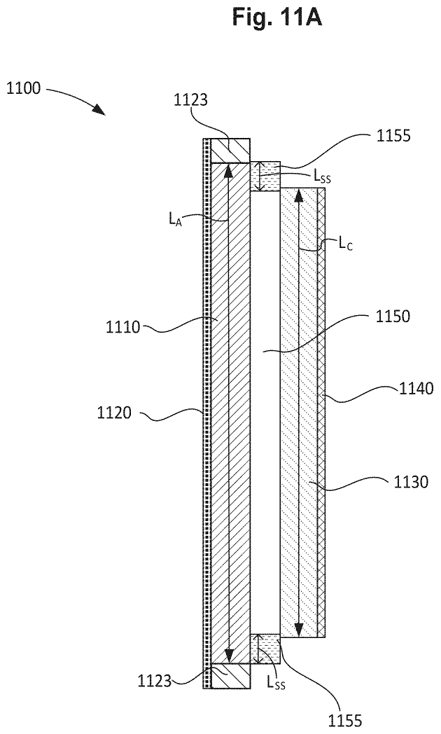

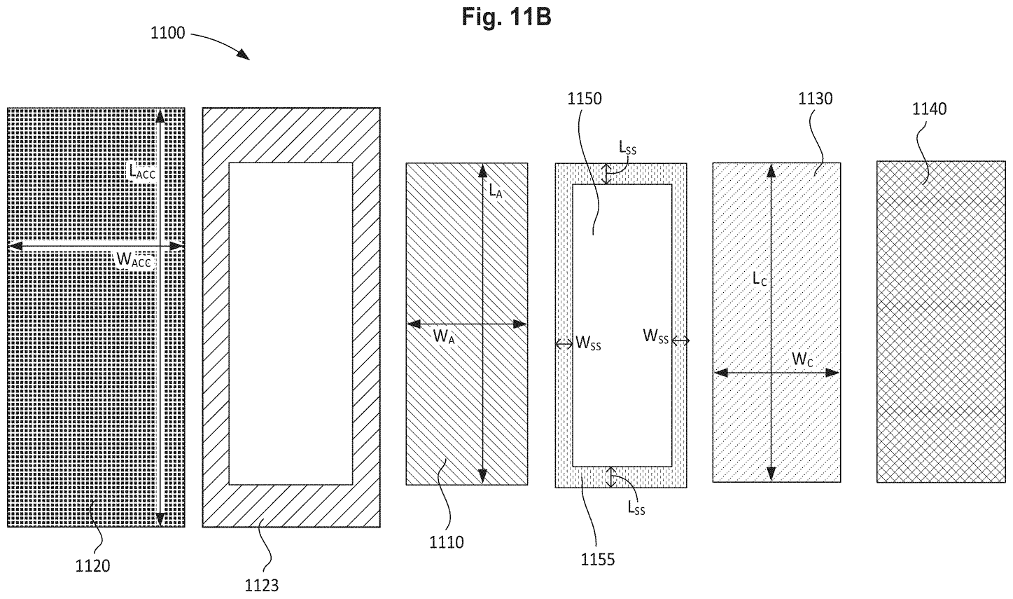

FIGS. 11A and 11B show an electrochemical cell 1100, according to an embodiment. The electrochemical cell 1100 includes an anode 1110 disposed on an anode current collector 1120, a cathode 1130 disposed on a cathode current collector 1140, and a separator 1150 disposed between the anode 1110 and the cathode 1130. As shown, the separator 1150 includes a separator seal 1155 oriented around an outside edge of the separator 1150. In some embodiments, an edge coating member 1123 can be disposed on the anode current collector 1120. In some embodiments, the anode current collector 1120 and/or the cathode current collector 1140 can be coupled to a plastic film or pouch material (not shown). The anode 1110 has an anode length L_{A} and an anode width W_{A}. The cathode 1130 has a cathode length L_{C} and a cathode width W_{C}. The separator seal 1155 has a characteristic length L_{SS} and a characteristic width W_{SS}. The anode current collector 1120 has a characteristic length L_{ACC} and a characteristic width W_{ACC}. In some embodiments, the anode 1110, the anode current collector 1120, the cathode 1130, the cathode current collector 1140, the separator 1150, the separator seal 1155, L_{A}, W_{A}, L_{C}, W_{C}, L_{SS}, and W_{SS} can be the same or substantially similar to the anode 310, the anode current collector 320, the cathode 330, the cathode current collector 340, the separator 350, the separator seal 355, L_{A}, W_{A}, L_{C}, W_{C}, L_{SS}, and W_{SS}, as described above with reference to FIG. 3. Thus certain aspects of the anode 1110, the anode current collector 1120, the cathode 1130, the cathode current collector 1140, the separator 1150, the separator seal 1155, L_{A}, W_{A}, L_{C}, W_{C}, L_{SS}, and W_{SS} are not described in greater detail herein.

As shown L_{ACC} is larger than L_{A} and W_{ACC} is larger than W_{A}. In other words, the anode current collector 1120 has larger length and width dimensions than the anode 1110. This difference in dimensions can have several benefits. The size difference between the anode current collector 1120 and the anode 1110 allows for placement of the edge coating member 1123 around the outside perimeter of the anode 1110. In some embodiments, the edge coating member 1123 can be less conductive than the anode 1110. In some embodiments, the combination of the edge coating member 1123 and the separator seal 1150 can deliver improved performance in prevention of plating of electroactive material near the anode 1110. In some embodiments, the edge coating member 1123 can include a UV-cured material. In some embodiments, the edge coating member 1123 can be coated to the separator 1150 to form all or a portion of the separator seal 1155. In some embodiments, the edge coating member 1123 can include an alloy with silicon and/or tin. In some embodiments, the edge coating member 1123 can include an intercalation compound. In some embodiments, the edge coating member 1123 can include hard carbon. In some embodiments, the edge coating member 1123 can have a higher potential than the ground, such that it has a resistance to plating. In some embodiments, the edge coating member 1123 can include lithium titanate (LTO). In some embodiments, the edge coating member 1123 can include titanium oxide (TiO₂). Further examples of edge coating members and framing members are described in U.S. Pat. No. 10,593,952, (the '952 patent), which is hereby incorporated by reference in its entirety.

In some embodiments, (W_{ACC}−W_{A} can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (W_{ACC}−W_{A} can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (W_{ACC}−W_{A} (e.g., at least about 1 μm and no more than about 10 cm or at least about 10 mm and no more than about 1 cm, inclusive of all values and ranges therebetween. In some embodiments, (W_{ACC}−W_{A} can be about 1 μm, about 5 μm, about 10 μm, about 50 μm, about 100 μm, about 500 μm, about 1 mm, about 5 mm, about 1 cm, about 5 cm, or about 10 cm.

In some embodiments, (L_{ACC}−L_{A} can be at least about 1 μm, at least about 5 μm, at least about 10 μm, at least about 50 μm, at least about 100 μm, at least about 500 μm, at least about 1 mm, at least about 5 mm, at least about 1 cm, or at least about 5 cm. In some embodiments, (L_{ACC}−L_{A} can be no more than about 10 cm, no more than about 5 cm, no more than about 1 cm, no more than about 5 mm, no more than about 1 mm, no more than about 500 μm, no more than about 100 μm, no more than about 50 μm, no more than about 10 μm, or no more than about 5 μm. Combinations of the above-referenced values are also possible for (L_{ACC}−L_{A} (e.g., at least about 1 μm and no more than about 10 cm or at least about 10 mm and no more than about 1 cm, inclusive of all values and ranges therebetween. In some embodiments, (L_{ACC}−L_{A} can be about 1 μm, about 5 μm, about 10 μm, about 50 μm, about 100 μm, about 500 μm, about 1 mm, about 5 mm, about 1 cm, about 5 cm, or about 10 cm.

In some embodiments, the cathode current collector 1140 can have length and width dimensions larger than those of the cathode 1130. In some embodiments, differences between dimensions of the cathode current collector 1140 and the cathode 1130 can be the same or substantially similar to those described above with reference to the anode 1110 and the anode current collector 1120. In some embodiments, a cathode edge coating member (not shown can be placed on the cathode current collector 1140.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, the term “about” and “approximately” generally mean plus or minus 10% of the value stated, e.g., about 250 μm would include 225 μm to 275 μm, about 1,000 μm would include 900 μm to 1,100 μm.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1-46. (canceled)

47. An electrochemical cell, comprising:
an anode disposed on an anode current collector;
a cathode disposed on a cathode current collector;
a separator disposed between the anode and the cathode, the separator having a first surface in contact with the anode, and a second surface opposite the first surface in contact with the cathode, the separator configured to allow movement of electroactive species between the anode and the cathode; and
a separator seal coupled to the separator, the separator seal configured to block movement of electroactive species.

48. The electrochemical cell of claim 47, wherein the separator has a length greater than a length of the cathode and the separator has a width greater than a width of the cathode, such that a portion of the second surface of the separator does not contact the cathode.

49. The electrochemical cell of claim 47, wherein the separator seal includes at least one of a tape, an adhesive, or an electrostatic coating.

50. The electrochemical cell of claim 47, wherein the separator includes pores.

51. The electrochemical cell of claim 50, wherein the separator seal includes a material disposed in the pores of portions of the separator

52. The electrochemical cell of claim 50, wherein the separator seal includes a coating material that coats a portion of the separator.

53. The electrochemical cell of claim 52, wherein the coating material includes polyethylene, polypropylene, high density polyethylene, polyethylene terephthalate, polystyrene, a thermosetting polymer, hard carbon, a thermosetting resin, a polyimide, or any combinations thereof

54. The electrochemical cell of claim 50, wherein the separator seal includes a high viscosity oil disposed in the pores in a portion of the separator, the high viscosity oil restricting flow of electroactive material through the portion of the separator.

55. The electrochemical cell of claim 47, wherein the separator seal is thermally bonded to the separator.

56. The electrochemical cell of claim 47, wherein the anode and/or the cathode includes a solid-state electrolyte.

57. An electrochemical cell, comprising:
an anode disposed on an anode current collector;
a cathode disposed on a cathode current collector; and
a separator disposed between the anode and the cathode, the separator including a permeable portion configured to allow movement of electroactive species therethrough and an impermeable portion configured to prevent movement of electroactive species therethrough.

58. The electrochemical cell of claim 57, wherein the separator has a length greater than a length of the anode and the separator has a width greater than a width of the anode, such that a portion of a surface of the separator adjacent to the anode does not contact the anode.

59. The electrochemical cell of claim 57, wherein the impermeable portion is UV-cured.

60. The electrochemical cell of claim 59, wherein a part of the permeable portion is coupled to a pouch.

61. The electrochemical cell of claim 57, wherein the separator includes a first layer and a second layer, the first layer including the impermeable section.

62. The electrochemical cell of claim 61, wherein substantially all of the second layer is permeable.

63. The electrochemical cell of claim 61, wherein the second layer has a higher melting temperature than a melting temperature of the first layer.

64. The electrochemical cell of claim 61, wherein an outside edge of the first layer is selectively melted to the second layer to form the impermeable section.

65. The electrochemical cell of claim 61, wherein the separator includes pores.

66. The electrochemical cell of claim 65, wherein the impermeable portion of the separator includes a material disposed in the pores to prevent the movement of electroactive species therethrough.

67. An electrochemical cell, comprising:
a first electrode;
a second electrode; and
a separator disposed between the first electrode and the second electrode, the separator having a first surface in contact with the first electrode and a second surface opposite the first surface in contact with the second electrode, the separator configured to allow movement of electroactive species between the first electrode and the second electrode;
a separator seal coupled to the separator, the separator seal configured to block movement of electroactive species; and
a pouch,
wherein the first electrode, the second electrode, the separator, and the separator seal are disposed in the pouch.

68. The electrochemical cell of claim 67, wherein the separator has a length greater than a length of the first electrode and the separator has a width greater than a width of the first electrode, such that a portion of the first surface of the separator does not contact the first electrode.

69. The electrochemical cell of claim 67, wherein the separator has a length greater than a length of the second electrode and the separator has a width greater than a width of the second electrode, such that a portion of the second surface of the separator does not contact the second electrode.

70. The electrochemical cell of claim 67, wherein the separator seal includes a material disposed in the pores of portions of the separator.
